(19) United States
(12) Patent Application Publication
(10) Pub. No.: US 2025/0172036 A1
(43) Pub. Date: May 29, 2025

(54) FRAME CORNER KEY

(71) Applicant: MI Windows and Doors, LLC, Gratz, PA (US)

(72) Inventor: Simon Cesare DALTON, Seattle, WA (US)

(73) Assignee: MI Windows and Doors, LLC, Gratz, PA (US)

(21) Appl. No.: 18/522,129

(22) Filed: Nov. 28, 2023

(51) Int. Cl. E06B 3/964

(52) U.S. Cl. CPC E06B 3/9644

(57) ABSTRACT

A corner key having a base with a first portion and a second portion; a first extension member movably connected to the first portion with a first connector integrally formed with the first extension member and the first portion; and a second extension member movably connected to the second portion with a second connector integrally formed with the second extension member and the second portion; wherein a portion of the first connector is movable as the first extension member is moved toward the first portion.

### BACKGROUND

Fenestration assemblies formed of more than one lineal member are typically connected with a corner key. The corner key acts to secure a first lineal to a second lineal.

### SUMMARY

In some aspects, the techniques described herein relate to a corner key for a frame including: a corner key having a base with a first portion and a second portion; a first extension member movably connected to the first portion with a first connector integrally formed with the first extension member and the first portion; and a second extension member movably connected to the second portion with a second connector integrally formed with the second extension member and the second portion; wherein a portion of the first connector is movable as the first extension member is moved toward the first portion.

In some aspects, the techniques described herein relate to a frame assembly including; At least a first corner key having a base, and a first extension member movably connected to the base with a first connector having a first crumple zone and a second extension member operatively coupled to the base; and a first lineal having a first hollow interior receiving the first extension member and a second lineal having a second hollow interior receiving the second extension member.

In some aspects, the techniques described herein relate to a method of assembling two frame lineal members including: providing a corner key including: a corner key having a base; a first extension member movably connected to the base with a connector having a first crumple zone integrally formed with the first extension member and the base; and a second extension member movably connected to the base with a separate second connector having a second crumple zone integrally formed with the second extension member and the base; securing the first extension member to a first lineal and securing the second extension member to the second lineal; and moving a first mating surface of the first lineal toward a second mating surface of the second lineal by collapsing the first crumple zone and collapsing the second crumple zone.

### BRIEF DESCRIPTION OF THE DRAWINGS

FIG. 1 is an isometric view of a fenestration frame.

FIG. 2 is an exploded view of the fenestration frame of FIG. 1.

FIG. 2A is a closeup exploded view of a first lineal, a second lineal corner key and fasteners.

FIG. 3 is an isometric view of the outwardly facing surfaces of a corner key.

FIG. 4 is an isometric view of the inwardly facing surfaces of a corner key.

FIG. 5A is an isometric side view of the corner key in a first relaxed state.

FIG. 5B is an isometric side view of the corner key in a second flexed state.

FIG. 5C is an outer isometric of the corner key of FIG. 5A showing the first extension member.

FIG. 5D is an outer isometric of the corner key of FIG. 5A showing the second extension member.

FIG. 6 is an isometric view of a first lineal member.

FIG. 7 is an isometric view of a second lineal member.

FIG. 8 is an isometric view of the corner key being secured to a first lineal and second lineal.

FIG. 9 is an isometric view of an adjustment fastener being extended through the first lineal member into the corner key.

FIG. 10 is a plan view of a corner key secured to a first lineal and a second lienal member.

### DETAILED DESCRIPTION OF THE EXAMPLE EMBODIMENTS

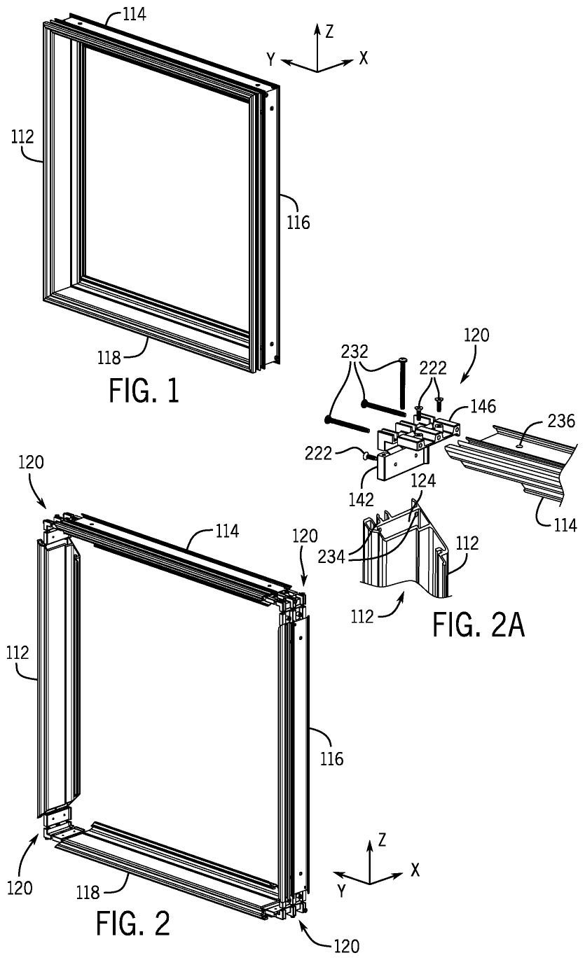

Referring to FIG. 1 a fenestration frame 110 includes a first lineal 112, a second lineal 114, a third lineal 116 and a fourth lineal 118. In one implementation frame 110 is a window frame with a glazing to be operatively secured thereto. First lineal 112 is perpendicular to second lineal 114. Referring to FIG. 2, a corner key 120 operatively connects first lineal 112 and second lineal 114 together along a miter joint forming a joint line 122. It is well known in the art that a miter joint is made by cutting each of two parts to be joined, across the main and/or side surface, usually at a 45° angle, to form a corner, usually to form a 90° angle, though it can comprise any angle greater than zero (0) degrees. Similarly, a second corner key 120 operatively connects second lineal 114 and third lineal 116, a third corner key 120 operatively connects third lineal 116 and fourth lineal 118, and a fourth corner key 120 operatively connects fourth lineal 118 to first lineal 112. In one implementation all corner keys 120 have an identical design. In one implementation all of the joints are miter joints. In one implementation it is also contemplated that one or more of the joints may be butt joints.

For the purposes of this application, the term “exterior” will refer to the direction toward the outside exterior of an enclosure or building while the term “interior” will refer to the direction inside the enclosure or building. Referring to FIG. 1 an X-Y-Z coordinate system is used to facilitate the description herein. In the coordinate system, the X-axis represents the direction perpendicular to the plane of the fenestrations. In one example where one implementation frame 110 is a window, the X-axis would be perpendicular to the glazing and the Y-Z plane would be parallel to the glazing. Thus, for a fenestration assembly on a wall of a building, the positive X-axis is directed from the exterior of the building toward the interior of the building. Where a feature or part of a component is being described, the area or feature will be referred to as the interior or exterior depending on whether feature in the installed position of FIG. 1 is closer to or further from the interior or exterior of the assembled fenestration.

The term inward or inwardly will be used to describe the general direction toward the glazing in the example of a window or a door panel in the example of a door. The term outward or outwardly will be used to describe the general direction away from the glazing in the example of a window and door panel in the example of a door.

For purposes of describing corner keys 120, the corner key 120 connecting first lineal 112 and second lineal 114 will be described in the orientation illustrated in FIG. 2A. The Figures present other views of corner key 120, first lineal 112 and second lineal 114. However, the interior and exterior surfaces will be referred to as the surface closest to the interior side of frame 110 and exterior side of frame 110 respectively.

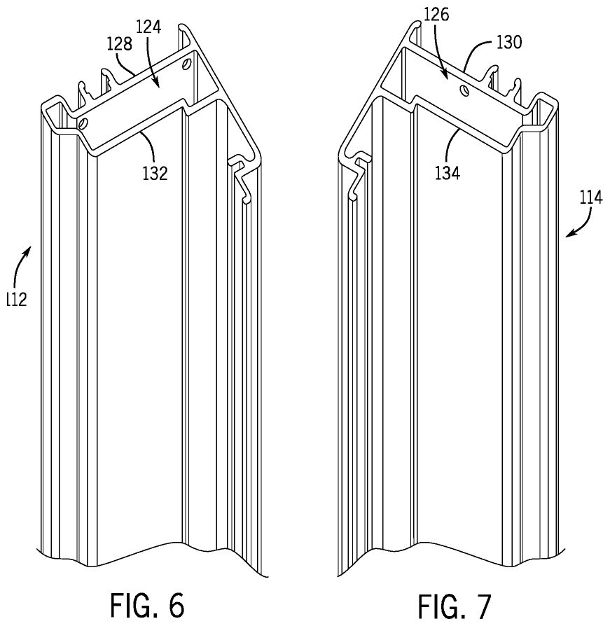

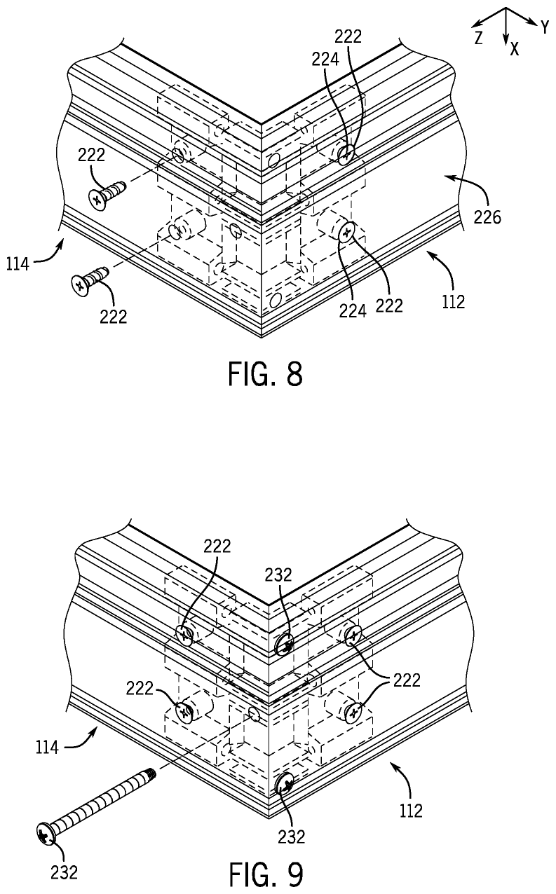

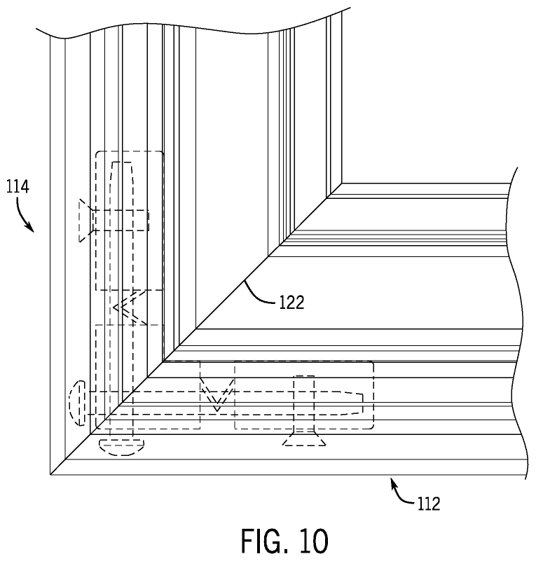

Referring to FIG. 2A, FIG. 6 first lineal 112 includes a hollow portion 124 receiving a first portion of corner key 120. Similarly, referring to FIG. 7 second lineal 114 includes a hollow portion 126 receiving a second portion of corner key 120. First lineal 112 includes a first lineal beveled mating face 128 and second lineal 114 includes a second lineal beveled mating face 130. As described herein when first lineal 112 and second lineal 114 are secured together with corner key 120 first beveled mating face 128 and beveled mating face 130 are adjacent one another and forming joint line 122 defined by the mating sections inward most profiles 132 and 134 of first lineal beveled mating face 128 and second lineal beveled mating face 130 respectively.

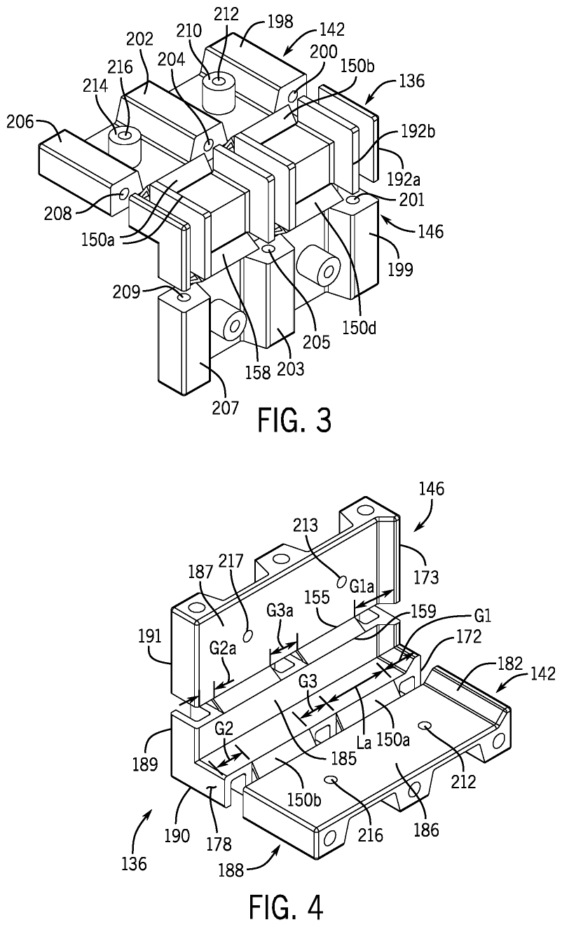

Referring to FIGS. 3, 4, 5A and 5B corner key 120 includes an L-shaped base portion 136 having a first leg 138 and a second leg 140. A first extension member 142 is operatively connected to first leg 138 with a first connector 144 and a second extension member 146 is operatively connected to second leg 140 with a second connector 148.

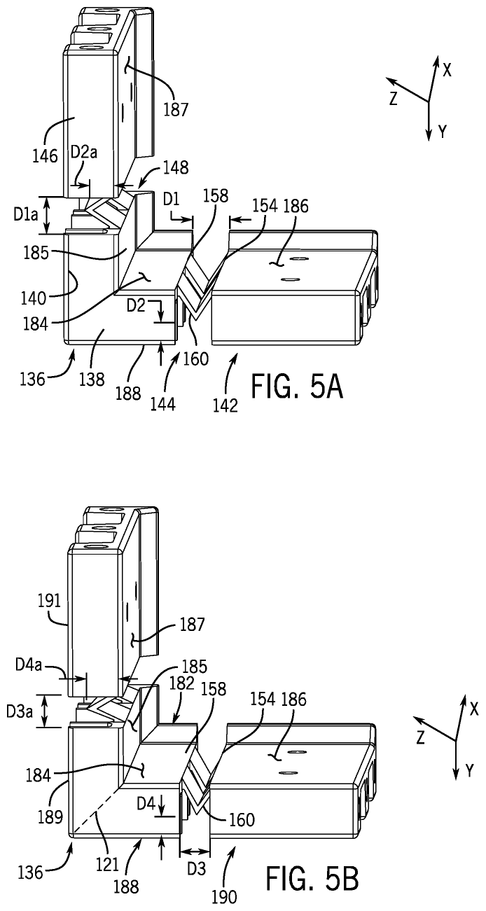

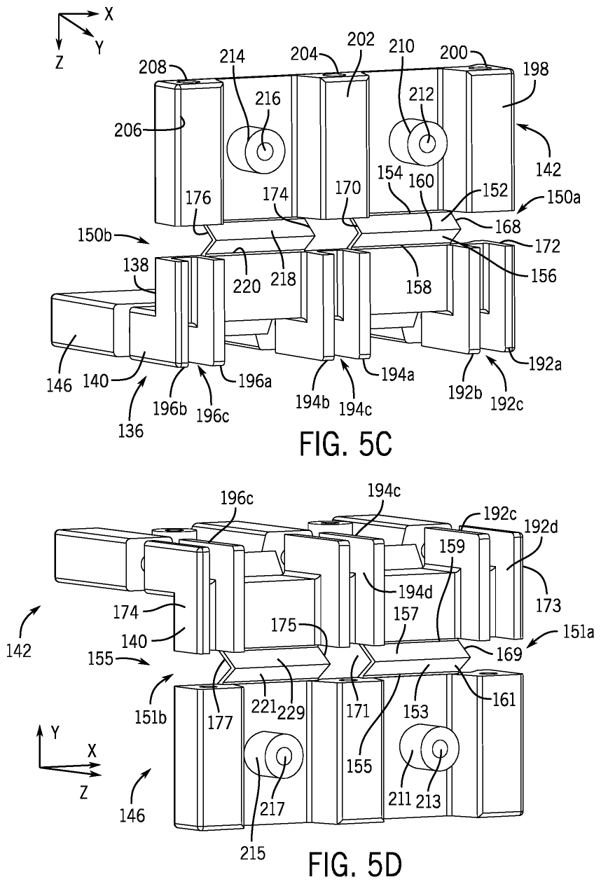

In one implementation the L-shaped base portion 136, first connector 144, first extension member 142, second connector 148, and second extension member 146 are formed of the same material as a single component. For example, L-shaped base portion 136 including first leg 138 and second leg 140, first extension member 142, first connector 144, second extension member 146 and second connector 148 are injected molded as a single component. Referring to FIG. 5A and FIG. 5B, corner key 120 is symmetrical about a plane extending through line 121. Stated another way, corner key 120 is symmetrical about a plane that is 45 degrees to both the first leg 138 and second leg 140 of L-shaped base portion 136. Corner key 120 includes a tab portion 182 along the interior portion of corner key 120 and not on the exterior portion of corner key 120, Accordingly, corner key 120 is not symmetrical about plane parallel to the YZ plane when the corner key 120 is in an installed orientation within frame 110. Stated another way in one implementation corner key 120 is not symmetrical about any plane extending perpendicular to through the planes defined by inward surface 184 and inward surface 185 of L-shaped base portion 136.

Referring to FIGS. 5A-5D, first connector 144 acts as a crumple zone allowing first extension member 142 to move toward and away from first leg 138 of L-shaped base portion 136 in an accordion fashion. First connector 144 includes a first V shaped member 150a having a first portion 152 having a longitudinal portion connected to first extension 142 along a line 154 that acts as a first living hinge. V shaped member 150a includes a second portion 156 having a longitudinal portion connected to first leg member 138 along a line 158 that acts as a second living hinge. First portion 152 and second portion 156 of V-shaped member 150a are connected along a line 160 that acts as a third living hinge.

A living hinge is well known in the art and is defined herein as a flexible hinge providing a flexure bearing, where the flexible hinge is made from the same material as the two rigid pieces it connects. In one implementation the flexible hinge material and the two portions it connects are made of the same material at the same time. For example, the flexible hinge material and the two portions connected thereto are formed in a single injection mold. In one implementation the flexible hinge has a thickness that is less than the thickness of each of the two portions that it connects.

Referring to FIG. 5A-5D, the regions defining lines, 154, and 158, have a thickness that is less than the thickness of first leg 138 and first extension member 142. Similarly, the region defining line 160 has a thickness that is less than first portion 152 and second portion 156 of V-shaped member 150a. This living hinge structure allows first portion 152 of V-shaped member 150a to move relative to first leg 138 along line 154. In this manner the living hinge allows first portion 152 to move relative to first extension 142 about line 154. In one implementation first portion 152 of V-shaped member 150a moves about line 154 without separating from first extension 142. Similarly, a living hinge is formed along line 158 and along line 160. As discussed further herein, first extension member 142 can move toward and away from first leg 138 by movement of first portion 152 along line 154, and line 160 and by movement of second portion 156 along line 160 and line 158.

Referring to FIG. 4, FIG. 5A and FIG. 5C, in one implementation first connector 144 is formed of two separate V-shaped members 150a and 150b spaced apart from one another proving a gap therebetween. For clarity purposes the first V-shaped member 150a is the innermost and the second V-shaped member 150b is the outermost V-shaped member. V-shaped member 150a includes an interior edge 168 and exterior edge 170. Interior edge 168 is spaced from an interior surface 172 of L-shaped base portion 136 providing a gap G1. Similarly, innermost V-shaped member 150b has an interior edge 174 and exterior edge 176. Interior edge 174 of V-shaped member 150b is spaced from the exterior surface 178 of L-shaped base portion 136 providing a gap G2. Exterior edge 170 of V-shaped member 150a is spaced from interior edge 174 of V-shaped member 150b providing a gap G3. As discussed herein gaps G1, G2 and G3 allow for fasteners to extend from first leg 138 to first extension member 142 without interfering with movement of V-shaped member 150a and V-shaped member 150b.

Referring to FIG. 5A-FIG. 5D, in one implementation line 158 is closely adjacent an inward surface 184 of first leg 138 and line 154 is closely adjacent an inward surface 186 of first extension member 142. Referring to FIG. 5A, in a first free state in which there is no outside force on first connector 144 the distance between first extension member 142 and first leg 138 of L-shaped base portion 136 is a predetermined distance D1. In the first free state the distance between line 160 and the outward surface 188 of base portion 136 is a predetermined distance D2, where D2 is greater than zero. Referring to FIG. 5B in an adjusted second state the distance D3 between first leg 138 and first extension member 142 is less than the distance D1. And the distance D4 between line 160 and outward surface 188 is less than the distance D2 but greater than zero. In one implementation the distance between line 154 and line 160 taken along first portion 152 of V-shaped member 150a is less than the distance between inward surface 184 and outward surface 188 taken along a direction perpendicular to inward surface 184. In this manner line 160 does not contact a surface of hollow portion when corner key 120 is in the fully installed position and in the adjusted second state.

Referring to FIG. 5A and FIG. 5B, in one implementation the distance between inward surface 184 and outward surface 188 is the same as the distance between inward surface 186 of first extension member 142 and an outward surface 190 of first extension member 142. In one implementation inward surface 184 of first leg 138 and inward surface 186 of first extension member 142 are co-planar. Similarly, in one implementation outward surface 188 of first leg 138 and outward surface 190 of first extension member 142 are co-planar.

Referring to FIG. 5B, in this manner it is possible to move first extension member 142 substantially close to first leg 138 without line 160 of V-shaped member 150 contacting an inside surface of hollow portion 126 of lineal 112.

Referring to FIG. 3 and FIG. 5CL-shaped base portion 136 includes three pairs of ribs, which each pair of ribs defining a throughway therebetween. The first pair of ribs 192a and 192b define a throughway 192c therebetween. Ribs 192a and 192b are L-shaped and extend through first leg 138 and second leg 140 of L-shaped base portion 136. A second pair of ribs 194a and 194b define a second throughway 194c therebetween. Ribs 194a and 194b are L-shaped and extend through first leg 138 and second leg 140 of L-shaped base portion 136. A third pair of ribs 196a and 196b are L-shaped and extend through first leg 138 and second leg 140 of L-shaped base portion 136. In one implementation ribs 192a, 192b, 194a, 194b, 196a and 196b form open channels that define the throughway. In one implementation the distance between the interior surface of 192a and exterior surface of 192b is equal to the distance of gap G1. In one implementation the distance between the interior surface of 194a and exterior surface of 194b is equal to the distance of gap G3. In one implementation the distance between the interior surface of 196a and exterior surface of 196b is equal to the distance of gap G2. Referring to FIG. 4, in one implementation the length La of V-shaped member 150a along the axis between interior surface 172 and exterior surface 178 is less than or equal to the distance between the exterior surface of 192b and the interior surface of 194a and the length of 150b is less than or equal to the distance between the exterior surface of 194b and the interior surface of 196a. In one implementation the length of 150b is equal to the length La of V-shaped member 150a

[symbol]

Referring to FIG. 3 and FIG. 5C First extension member 142 includes a first tab 198 having a hole 200 extending at least partially therethrough that is co-axial with a longitudinal axis of the channel defined by the first pair of ribs 192a and 192b. First extension member 142 also includes a second tab 202 having a hole 204 extending at least partially therethrough that is co-axial with a longitudinal axis of the channel defined by the second pair of ribs 194a and 194b. Additionally, first extension member 142 includes a third tab 206 having a hole 208 extending at least partially therethrough that is co-axial with a longitudinal axis of the channel defined by the third pair of ribs 196a and 196b.

Referring to FIG. 3, first extension member 142 includes a first boss 210 having a hole 212 extending at least partially therethrough wherein the longitudinal axis of the hole 212 is perpendicular to inward surface 186 and generally is spaced from and perpendicular the longitudinal axis of hole 200 of tab 198. Similarly, first extension member 142 includes a second boss 214 having a hole 216 extending at least partially therethrough. In one implementation first boss 210 is positioned between first tab 198 and second tab 202 and second boss 214 is positioned between second tab 202 and third tab 206. Hole 212 and hole 216 extend through inward surface 186.

Referring to FIG. 5D, in one implementation V-shaped member 150b includes first portion 218 and a second portion 220 that have has the same relative dimensions related to inward surface 184 and outward surface 188, as well as the same relative dimensions to inward surface 186 and outward surface 190 as V-shaped member 150a.

Referring to FIG. 5D, Second connector 148 includes a V-shaped members 151a and 151b having similar structure and operation as V-shaped members 150a and 150b allowing second extension member 146 to move toward and away from second leg 140 of L-shaped base portion 136.

Referring to FIG. 5A-FIG. 5D, second connector 148 acts as a crumple zone allowing second extension member 146 to move toward and away from second leg 140 of L-shaped base portion 136 in an accordion fashion. Second connector 148 includes a first V shaped member 151a having a first portion 153 having a longitudinal portion connected to second extension 146 along a line 155 that acts as a first living hinge. V-shaped member 151a includes a second portion 157 having a longitudinal portion connected to second leg 140 of L-shaped base portion 136 along a line 159 that acts as a second living hinge. First portion 153 and second portion 157 of V-shaped member 151a are connected along a line 161 that acts as a third living hinge.

Referring to FIG. 5D, the regions defining line 155, and line 159, have a thickness that is less than the thickness of second leg 140 and second extension member 146. Similarly, the region defining line 161 has a thickness that is less than the thickness of first portion 153 and second portion 157 of V-shaped member 151a. This living hinge structure allows first portion 153 of V-shaped member 151a to move relative to second extension 146 along line 155. In this manner the living hinge allows second portion 157 to move relative to second leg 140 about line 159. In one implementation first portion 153 of V-shaped member 151a moves about line 155 without separating from first extension 146. Similarly, a living hinge is formed along line 159 and along line 161. As discussed further herein, second extension member 146 can move toward and away from second leg 140 by movement of V-shaped member 151a along lines 155, line 161 and line 159.

Referring to FIG. 4 and FIG. 5D in one implementation second connector 148 is formed of two separate V-shaped members 151a and 151b spaced apart from one another proving a gap therebetween. For clarity purposes the first V-shaped member 151a is the innermost and the second V-shaped member 151b is the outermost V-shaped member. V-shaped member 151a includes an interior edge 169 and exterior edge 171. Interior edge 169 is spaced from an interior surface 173 of L-shaped base portion 136 providing a gap G1a. Similarly, innermost V-shaped member 151b has an interior edge 175 and exterior edge 177. Interior edge 175 of V-shaped member 151b is spaced from the exterior surface 179 of L-shaped base portion 136 providing a gap G2. Exterior edge 171 of V-shaped member 151a is spaced from interior edge 175 of V-shaped member 151b providing a gap G3. As discussed herein gaps G1a, G2a and G3a allow for fasteners to extend from second leg 140 to second extension member 146 without interfering with movement of V-shaped member 151a and V-shaped member 151b.

Referring to FIG. 5A, FIG. 5B and FIG. 5D, in one implementation line 155 is closely adjacent an inward surface 187 of second extension 146 and line 159 is closely adjacent an inward surface 185 of first leg 140 of L-shaped base portion 136. Referring to FIG. 5A, in a first free state in which there is no outside force on second connector 148 the distance between second extension member 146 and L-shaped base portion 136 is a predetermine distance D1a. In the first free state the distance between line 161 and the outward surface 189 of base portion 136 is a predetermined distance D2a, where D2a is greater than zero. Referring to FIG. 5B in an adjusted second state the distance D3a between second leg 140 and second extension member 146 is less than the distance D1a, and the distance D4a between line 161 and outward surface 189 is less than the distance D2a but greater than zero. In one implementation the distance between line 155 and line 161 taken along first portion 153 of V-shaped member 151a is less than the distance between inward surface 185 and outward surface 189 taken along a direction perpendicular to inward surface 185. In this manner line 161 does not contact a surface of hollow portion when corner key 120 is in the fully installed position and in the adjusted second state.

In one implementation the distance between inward surface 185 and outward surface 189 is the same as the distance between inward surface 187 of first extension member 142 and an outward surface 191 of second extension member 146. In one implementation inward surface 185 of second leg 140 and inward surface 187 of second extension member 146 are co-planar. Similarly, in one implementation outward surface 189 of second leg 140 of L-shaped base portion 136 and outward surface 191 of second extension 146 are co-planar.

Referring to FIG. 5B, it is possible to move second extension member 146 toward second leg 140 without line 161 of V-shaped member 151 contacting an inside surface of hollow portion 126 of lineal 114.

As discussed herein above referring to FIG. 3 and FIG. 5C L-shaped base portion 136 includes three pairs of ribs, which each pair of ribs defining throughways therebetween that allow fasteners to extend therethrough. A portion of each rib extends into leg 140 of L-shaped base portion 136 and defines a throughway 192d, 194d and 196d that is perpendicular to and intersects with throughway 192c, 194c, and 196c respectively.

Referring to FIG. 3 and FIG. 5D second extension member 146 includes a first tab 199 having a hole 201 extending at least partially therethrough that is co-axial with a longitudinal axis of the channel 192d. Second extension member 146 also includes a second tab 203 having a hole 205 extending at least partially therethrough that is co-axial with a longitudinal axis of the channel 194d. Additionally, second extension member 146 includes a third tab 207 having a hole 209 extending at least partially therethrough that is co-axial with a longitudinal axis of the channel 196d.

Second extension member 146 includes a first boss 211 having a hole 213 extending at least partially therethrough wherein the longitudinal axis of the hole 213 is perpendicular to inward surface 187 and generally is spaced from and perpendicular the longitudinal axis of hole 201 of first tab 199. Similarly, first extension member 142 includes a second boss 215 having a hole 217 extending at least partially therethrough. In one implementation first boss 211 is positioned between first tab 199 and second tab 203 and second boss 215 is positioned between second tab 203 and third tab 207. Hole 213 and hole 217 extend through inward surface 185.

Referring to FIG. 5D, in one implementation V-shaped member 151b includes first portion 219 and a second portion 221 that have has the same relative dimensions related to inward surface 185 and outward surface 189, as well as the same relative dimensions to inward surface 187 and outward surface 191 as V-shaped member 151a.

The assembly of a frame 110 includes inserting first extension member 142 of a first corner key 120 into hollow portion 124 of first lineal 112 and inserting second extension member 146 of first corner key 120 into hollow portion 126 of second lineal beveled mating face 130. A pair of fasteners 222 such as screws are placed through a respective pair of apertures 224 extending through an outwardly surface 226 of first lineal 112 and into respective holes 212 and 216 of first extension member 142. Another pair of screws 222 are placed through a pair of apertures 228 extending through an outwardly surface 230 of second lineal 114 and into holes 213 and 217 of second extension member 146. In this manner first lineal 112 is secured to first extension member 142 and second lineal 114 is secured to second extension member 146.

First lineal beveled mating face 128 and second lineal beveled mating face 130 are brought into tight contact with one another by fasteners 232. A first pair of fastener 232 extend through a pair of apertures 234 in outwardly surface 226 of first lineal and extend through throughway 192c and throughway 196c in L-shaped base portion 136 until they engage with hole 200 in first tab 198 and hole 208 of third tab 206. Fasteners 232 engage the longitudinal interior surface of hole 200 and hole 208 and act to move first extension member 142 toward L-shaped base portion 136. In this manner first lineal beveled mating face 128 is brought into tight contact with second lineal beveled mating face 130. Finally, a fastener 232 extends through an aperture 236 in second lineal 114 through channel 194c and engages first extension member 142 via hole 204. Fasteners 232 engages the wall of hole 204 and moves first extension member 142 closer to L-shaped base portion 136 thereby further tightening first lineal 112 and second lineal 114 along first lineal beveled mating face 128 and second lineal beveled mating face 130 respectively. As first extension member 142 is moved toward L-shaped base portion 136 V-shaped members 150a 150b move about their living hinges to maintain a connection between extension member 142 and L-shaped base portion 136. As fasteners 232 extend through L-shaped base portion 136 and into extensions 142 and 146 and are tightened first lineal beveled mating face 128 and second lineal beveled mating face 130 are drawn tightly together while V-shaped hinges 150a-150b, 151a and 151b flex about lines.

The remaining third lineal 116 and fourth lineal 118 are connected to each other and first lineal 112 and second lineal 114 with corner keys 120 in the same manner as described above. Referring to FIG. 2, in one implementation, all four lineals 112, 114, 116, and 118 and corner keys 120 are placed together simultaneously after which fasteners 222 operatively secure the extension members 142 and 146 of each corner key 120 to respective pairs of lineals.

In one implementation fasteners 222 and fasteners and fasteners 232 are self-threading screws that create threads in the holes extending through tabs 198, 202, 206, 199, 203, 207 and holes extending through bosses 210, 211, 214 and 215. One such self-threading screw available is sold under the trademark Plastite™.

Referring to FIG. 5A, in one implementation first connector 144 includes a crumple zone having a portion that crumples along a first linear direction as first extension member 142 is moved toward first leg 138 of L-shaped base portion 136. Additionally, in this implementation second connector 148 includes a portion that crumples along a second linear direction as second extension member 146 is moved toward second leg 140 of L-shaped base portion 136. In one implementation the first linear direction is a first straight line and the second linear direction is a second straight line perpendicular to the first straight line. The portions of first connector 144 and second connector 148 collapse on itself either with wrinkles or in the form of an accordion shape. V-shaped members discussed herein above act as a crumple zone. By example of V-shaped member 150a, first portion 152 and second portion 156 act as a crumple zone by moving toward each other by flexing about living hinge lines 154, 160 and 158. However, it is contemplated that instead of a living hinge, the crumple zone may buckle as first extension member 142 and second extension member 146 are moved toward l-shaped base portion 136. The crumple portion or zone includes material that gets crushed together or pressed into wrinkles, rumples, or collapses on itself.

In a one implementation frame 110 is a door frame for a door to be secured thereto with hinges or other fastener devices. Referring to FIG. 1, one implementation frame 110 includes four lineal members. However, it is contemplated that one implementation frame 110 may include three lineal members or more than four lineal members. For example, frame 110 may be triangular or other not rectangular/square shape. In one implementation lineal members extend along a straight line, however, it is also possible that the lineal members are arcuate and are curvilinear.

In one implementation first connector 144 and second connector 148 are a spring such as a helical spring. In one implementation first connector 144 and second connector 148 are any type of living hinge that has a first free state that permits movement of first extension member 142 and second extension member 146 toward first leg 138 and second leg 140 respectively in a second adjusted state. In one implementation first connector 144 and second connector 148 include a slidable connection that has a first position that permits movement of first extension member 142 and second extension member 146 toward first leg 138 and second leg 140 in a second position. In one implementation first connector 144 is integrally formed with first leg 138 and first extension member 142. In one implementation first connector 144 is a separately formed component secured to one or both of first leg 138 and first extension member 142.

In one implementation, first connector 144 include a portion that is frangible and breaks when the first extension member moves toward the first portion of the base. Similarly, second extension member 146 includes a portion that is frangible and breaks when the second extension member moves toward the second portion of the base. In one non-limiting example the connector is a single straight member that breaks either at an end connected to the extension member or intermediate the first extension member and the first portion of the base. In one implementation first connector 144 is flexible and folds upon itself in a uniform manner as the first extension member moves towards the first portion of the base. For example, first connector can have a sine wave shape and/or other arcuate shape that is flexible such that the distance between each sine wave portion changes as the extension member is moved toward and away from the base. In one implementation first connector 144 is formed of a material that creases upon itself as the first extension member moves toward the first portion of the base. In one example first connector 144 and second connector 148 are sufficiently rigid that the orientation of first extension member 142 and second extension member 146 relative to base portion 136 does not change as first extension member 142 and second extension member 146 are placed within the hollow portion 124 and hollow portion 126 of first lineal 112 and second lineal 114.

In some aspects, the techniques described herein relate to a corner key for a frame including: a corner key having a base with a first portion and a second portion; a first extension member movably connected to the first portion with a first connector integrally formed with the first extension member and the first portion; and a second extension member movably connected to the second portion with a second connector integrally formed with the second extension member and the second portion; wherein a portion of the first connector is movable as the first extension member is moved toward the first portion.

In some aspects, the techniques described herein relate to a corner key, wherein each of the first connector and the second connector include a living hinge.

In some aspects, the techniques described herein relate to a corner key, wherein each of the first connector and the second connector include a pair of connectors spaced from one another.

In some aspects, the techniques described herein relate to a corner key, wherein the first connector is V-shaped including a first leg connected to the first portion of the base with a first living hinge, a second leg connected to the first extension member, the first leg and the second leg being connected to one another with a third living hinge.

In some aspects, the techniques described herein relate to a corner key, wherein the first extension member is a first predetermined distance from the first portion in a first state.

In some aspects, the techniques described herein relate to a corner key, wherein the base includes three L-shaped passageways.

In some aspects, the techniques described herein relate to a corner key, wherein the first extension member includes three tabs each having a tab hole extending there through, wherein each hole has a longitudinal axis co-linear with a portion of a respective L-shaped passageway.

In some aspects, the techniques described herein relate to a corner key, wherein the first extension member includes a pair of bosses each including a boss hole extending therein, wherein each boss hole has a longitudinal axis that extends in a direction perpendicular to the longitudinal axis of the tab holes.

In some aspects, the techniques described herein relate to a corner key, wherein the first connector includes an integrally formed crumple portion that crumples when the first extension member is moved toward the base.

In some aspects, the techniques described herein relate to a corner key, wherein the first connector includes an integrally formed frangible portion that factures when the first extension member is moved toward the base.

In some aspects, the techniques described herein relate to a corner key, wherein the first connector includes an integrally formed flexible portion that flexes when the first extension member is moved toward the base.

In some aspects, the techniques described herein relate to a corner key, wherein the corner key is only symmetrical about a single plane.

In some aspects, the techniques described herein relate to a frame assembly including; At least a first corner key having a base, and a first extension member movably connected to the base with a first connector having a first crumple zone and a second extension member operatively coupled to the base; and a first lineal having a first hollow interior receiving the first extension member and a second lineal having a second hollow interior receiving the second extension member.

In some aspects, the techniques described herein relate to a frame assembly, further including a second corner key connecting the second lineal to a third lineal, a third corner key connecting the third lineal to a fourth lineal and a fourth corner key connecting the fourth lineal to the first lineal, wherein each of the first corner key, second corner key, third corner key and fourth corner key are identical.

In some aspects, the techniques described herein relate to a frame assembly, wherein the first crumple zone is a V-shaped member having a first portion connected to the base with a first living hinge, a second portion connected to the first extension member and a second living hinge, the first portion and the second portion of the V-shaped member being connected with a third living hinge.

In some aspects, the techniques described herein relate to a frame assembly, wherein the second connector includes a second crumple zone connecting the base to the second extension member.

In some aspects, the techniques described herein relate to a frame assembly, wherein the base, the first crumple zone, the first extension member, the second crumple zone and the second extension member are integrally formed as a single component.

In some aspects, the techniques described herein relate to a frame assembly, wherein the single component is formed from a thermoplastic material in a single injection molding step.

In some aspects, the techniques described herein relate to a frame assembly, wherein the first extension member is connected to the first lineal with a first fastener and is moved toward the base with a second fastener extending through the second lineal.

In some aspects, the techniques described herein relate to a method of assembling two frame lineal members including: providing a corner key including: a corner key having a base; a first extension member movably connected to the base with a connector having a first crumple zone integrally formed with the first extension member and the base; and a second extension member movably connected to the base with a separate second connector having a second crumple zone integrally formed with the second extension member and the base; securing the first extension member to a first lineal and securing the second extension member to the second lineal; and moving a first mating surface of the first lineal toward a second mating surface of the second lineal by collapsing the first crumple zone and collapsing the second crumple zone.

Although the present disclosure has been described with reference to example embodiments, workers skilled in the art will recognize that changes may be made in form and detail without departing from the spirit and scope of the defined subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described is manifestly intended to be as broad as possible. For example, unless specifically otherwise noted, the definitions reciting a single particular element also encompass a plurality of such particular elements.

What is claimed is:

1. A corner key for a frame comprising:
a corner key having a base with a first portion and a second portion;
a first extension member movably connected to the first portion with a first connector integrally formed with the first extension member and the first portion; and
a second extension member movably connected to the second portion with a second connector integrally formed with the second extension member and the second portion;
wherein a portion of the first connector is movable as the first extension member is moved toward the first portion.

2. The corner key of claim 1, wherein each of the first connector and the second connector include a living hinge.

3. The corner key of claim 2, wherein each of the first connector and the second connector include a pair of connectors spaced from one another.

4. The corner key of claim 1, wherein the first connector is V-shaped including a first leg connected to the first portion of the base with a first living hinge, a second leg connected to the first extension member, the first leg and the second leg being connected to one another with a third living hinge.

5. The corner key of claim 1, wherein the first extension member is a first predetermined distance from the first portion in a first state.

6. The corner key of claim 1, wherein the base includes three L-shaped passageways.

7. The corner key of claim 1, wherein the first extension member includes three tabs each having a tab hole extending there through, wherein each hole has a longitudinal axis co-linear with a portion of a respective L-shaped passageway.

8. The corner key of claim 7, wherein the first extension member includes a pair of bosses each including a boss hole extending therein, wherein each boss hole has a longitudinal axis that extends in a direction perpendicular to the longitudinal axis of the tab holes.

9. The corner key of claim 1, wherein the first connector includes an integrally formed crumple portion that crumples when the first extension member is moved toward the base.

10. The corner key of claim 1, wherein the first connector includes an integrally formed frangible portion that factures when the first extension member is moved toward the base.

11. The corner key of claim 1, wherein the first connector includes an integrally formed flexible portion that flexes when the first extension member is moved toward the base.

12. The corner key of claim 1, wherein the corner key is only symmetrical about a single plane.

13. A frame assembly including;
At least a first corner key having a base, and a first extension member movably connected to the base with a first connector having a first crumple zone and a second extension member operatively coupled to the base; and
a first lineal having a first hollow interior receiving the first extension member and a second lineal having a second hollow interior receiving the second extension member.

14. The frame assembly of claim 13, further including a second corner key connecting the second lineal to a third lineal, a third corner key connecting the third lineal to a fourth lineal and a fourth corner key connecting the fourth lineal to the first lineal, wherein each of the first corner key, second corner key, third corner key and fourth corner key are identical.

15. The frame assembly of claim 13, wherein the first crumple zone is a V-shaped member having a first portion connected to the base with a first living hinge, a second portion connected to the first extension member and a second living hinge, the first portion and the second portion of the V-shaped member being connected with a third living hinge.

16. The frame assembly of claim 15, wherein the second connector includes a second crumple zone connecting the base to the second extension member.

17. The frame assembly of claim 16, wherein the base, the first crumple zone, the first extension member, the second crumple zone and the second extension member are integrally formed as a single component.

18. The frame assembly of claim 17, wherein the single component is formed from a thermoplastic material in a single injection molding step.

19. The frame assembly of claim 17, wherein the first extension member is connected to the first lineal with a first fastener and is moved toward the base with a second fastener extending through the second lineal.

20. A method of assembling two frame lineal members comprising:
providing a corner key including:
a corner key having a base;
a first extension member movably connected to the base with a connector having a first crumple zone integrally formed with the first extension member and the base; and
a second extension member movably connected to the base with a separate second connector having a second crumple zone integrally formed with the second extension member and the base;
securing the first extension member to a first lineal and securing the second extension member to the second lineal; and
moving a first mating surface of the first lineal toward a second mating surface of the second lineal by collapsing the first crumple zone and collapsing the second crumple zone.
